(19) United States
(12) Patent Application Publication
(10) Pub. No.: US 2004/0080782 A1
(43) Pub. Date: Apr. 29, 2004

(54) Methods and apparatuses for sending message data from a digital sender

(76) Inventor: Arti Shukla, Eagle, ID (US)

Correspondence Address: HEWLETT-PACKARD COMPANY, Intellectual Property Administration, P. O. Box 272400, Fort Collins, CO, 80527-2400, US

(21) Appl. No.: 10/281,531

(22) Filed: Oct. 28, 2002

(51) Int. Cl. G06F 15/00; G06F 3/12; G06F 13/00

(52) U.S. Cl. 358/1.15; 358/402; 398/106

(57) ABSTRACT

Methods and apparatuses are provided for sending message data from a digital sender device based on addressing information provided by a portable device.

### TECHNICAL FIELD

The present invention relates generally to computing and communication devices and more particularly to methods and apparatuses for sending message data from a digital sender device based on addressing information provided by a portable device.

### BACKGROUND

Electronic messaging, such as, sending and receiving electronic mail (e-mail) continues to grow in popularity. There is growing list of devices that can be used to send and/or receive e-mail. It is not uncommon, for example, to find e-mail being exchanged between users of personal computers (PCs) and users of mobile telephones/pagers.

A more recent development has been the introduction of devices sometimes referred to as digital senders. Digital sender devices basically allow users to send e-mail to one or more other users by entering the other user(s) e-mail addresses and/or selecting a defined list of recipients. The user then scans one or more documents using the digital sender device. The digital sender then forwards a digital representation of the scanned documents to the listed recipients over an interconnecting network.

Digital sender devices such as this are useful, for example, in offices, conference rooms, business centers, home offices, schools, and other like settings where it would be beneficial to enable users to quickly send e-mails without requiring a more extensive computing arrangement. Digital senders can be especially useful to visitors that may not have the ability to access local computing networks, etc. Many visitors and other mobile users do carry portable devices, such as, for example, notebook computers, personal digital assistants (PDAs), mobile telephones/pagers, and the like. It would be beneficial if such portable devices could interact with digital sender and other like devices. In particular, it would be beneficial for users to be able to generate message data using a digital sending device and then provide the digital sending device with one or more recipient addresses using a portable device.

Consequently, there is a need for improved methods and apparatuses that can provide such a capability.

### SUMMARY

The above-stated needs and/or others are met, for example, by a method for use in a digital sender device that is capable of sending message data over a communication network. The method includes optically scanning at least one object to form corresponding scanned object data, receiving recipient address data from a portable device, and addressing the message data using the recipient address data. In certain implementations the method further includes sending the message data over the communication network to at least one remote device connected to the communication network and operatively associated with a user address that is included in the recipient address data. The method may also include accepting user input through a user interface of the digital sender device. Here, the user input may include user provided data such as address data, subject data, and text data. The method then includes forming the message data by combining the scanned object data, the recipient address data, and the user provided data.

In accordance with other exemplary implementations, an apparatus is provided that is capable of sending message data. The apparatus includes a scanning mechanism configurable to optically scan at least one object to form corresponding scanned object data and at least one communication port configurable to receive recipient address data from a portable device over a communication link. Here, the recipient address data includes at least one address associated with an intended message data recipient. The apparatus further includes logic that is operatively coupled to the scanning mechanism and the communication port. The logic is configured to form message data by combining the scanned object data and the recipient address data.

### BRIEF DESCRIPTION OF THE DRAWINGS

A more complete understanding of the various methods and apparatuses of the present invention may be had by reference to the following detailed description when taken in conjunction with the accompanying drawings wherein:

FIG. 1 is a block diagram depicting a computing and communication environment having a digital sender device and a portable device, in accordance with certain exemplary implementations of the present invention.

FIG. 2 is a flow diagram depicting a method for use in a computing and communication environment having a digital sender device and a portable device as in FIG. 1, for example, in accordance with certain exemplary implementations of the present invention.

### DETAILED DESCRIPTION

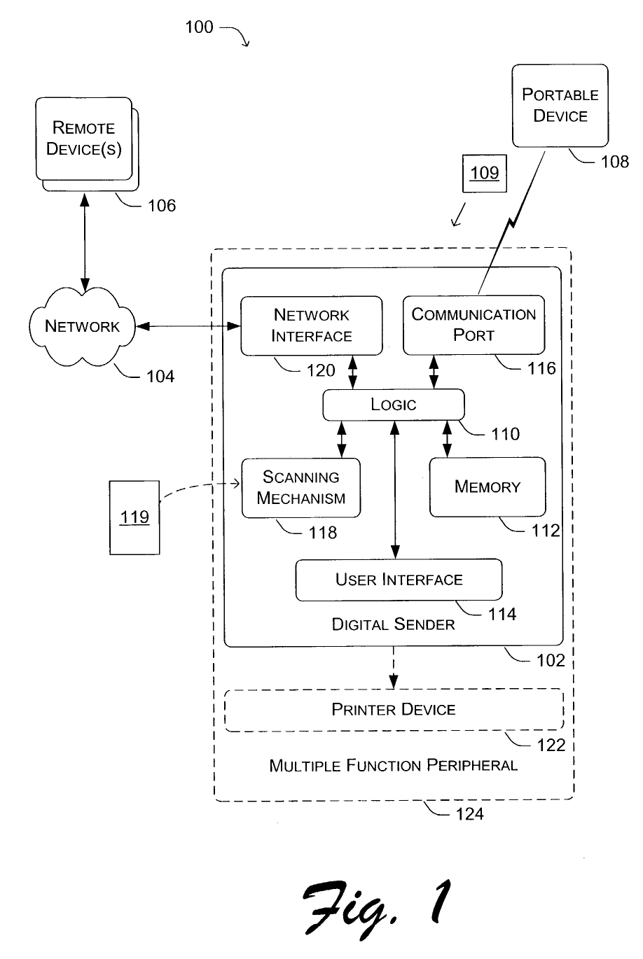

FIG. 1 is a block diagram depicting an exemplary computing and communication environment 100 having a digital sender device 102 that is connected to a network 104, which is further connected to one or more remote devices 106. Digital sender device 102 is also illustrated as being connected to a portable device 108 by way of a wireless communication link.

Network 104 is representative of one or more communication links, either wired or wireless that are capable of carrying data between digital sender 102 and at least one remote device 106. In certain exemplary implementations, network 104 includes a local area network (LAN), a wide area network (WAN), an intranet, the Internet, or other similar network.

Remote device 106 is representative of any device that is capable of exchanging data over network 104. Thus, by way of example, remote device 106 may include a personal computer (PC) or a server computer or perhaps even another digital sender device and/or portable device.

Here, digital sender device 102 is configured to allow a user to scan an object(s) 119, such as, e.g., a document, and send the resulting scanned object data out over network 104 to one or more remotes devices 106 in the form of message data. The message data may, for example, include electronic mail (i.e., e-mail) message data from the user of the digital sender device 102 to the user(s) of the remote device(s) 106. Here, an e-mail message would include the scanned object data in some manner.

For example, the scanned object data may be included in the e-mail message data as an attached file. The scanned object data may include Portable Document Format (PDF) formatted data, tagged image file format (TIFF) formatted data, Joint Photographic Experts Group (JPEG) formatted data, bit-map formatted data, optical character recognition (OCR) related data, American Standard Code for Information Interchange (ASCII) formatted data, and/or other forms of encoded data, including, e.g., encrypted data, etc.

Digital sender 102 includes a user interface 114 that is configured to allow the user to input information and/or make selections associated with the operation of digital sender device 102 and/or the preparation of the message data. By way of example, user interface 114 may include a keypad or keyboard and/or display (not shown). The display, for example, may include a liquid crystal display (LCD) or the like. In certain implementations the display may include a touch-screen input/output device. Thus, with user interface 114, the user can be prompted to enter user input data, such as, e.g., the recipient(s) e-mail address information, the subject of the e-mail, the text or body of the e-mail, etc. As further illustrated in FIG. 1, digital sender 102 is also configured, in accordance with certain aspects of the present invention, to allow a user of a portable device 108 to provide recipient address data 109 to digital sender device 102.

Portable device 108 is representative of any electronic device capable of providing recipient address data 109 to digital sender 102 over either a wireless or wired communication link. Thus, for example, portable device 108 may include a portable handheld computer, a notebook computer, a personal digital assistant (PDA), a wearable computer device, a mobile telephone, a pager, a two-way radio, a media player device, a digital camera device, and other like electronic devices.

In this manner, a user of a portable device 108 is able to take advantage of not only the messaging capabilities and network access provided by digital sender 102, but also any existing recipient address data that they have stored on portable device 108. As such, the user can save time by not having to enter recipient addresses into digital sender device 108.

In accordance with certain other aspects of the present invention, digital sender device 102 may also be configured to provide a copy of the resulting modified message data back to portable device 108, for example, over the wireless communication link there between.

In accordance with still other aspects of the present invention, digital sender device 102 may be included within a multiple function peripheral (MFP) device 124. As its name implies, MFP device 124 is configured to provide multiple functions. In this example, the functions provided by MFP device 124 include those provided by digital sender device 102 and a printer device 122. Consequently, the user of digital sender device 102 and/or portable device 108 may also print out a hardcopy of any applicable portions of the message data.

To accomplish the various exemplary tasks as described above and others, digital sender 102 includes logic 110, which is operatively coupled to memory 112, a user interface 114, at least one communication port 116, a scanning mechanism 118, and at least one network interface 120. When included in MFP device 124, logic 110 would also be operatively coupled to printer device 122, for example.

Logic 110 is representative of any hardware, firmware and/or software that is configured to perform certain functions associated with the operation of digital sender 102 and, if applicable, MFP 124. Hence, as those skilled in the art will recognize, logic 110 may include dedicated logic and/or one or more processors configured in accord with software instructions, for example.

Memory 112 is representative of any type of data storage mechanism that can be accessed by at least logic 110. Memory 112 may therefore include, for example, some form of random access memory (RAM), some form of read only memory (ROM), and/or other like solid-state data storage mechanism. Memory 112 may include magnetic and/or optical data storage mechanism.

Scanning mechanism 118 is representative of any optical scanner technology that may be employed to produce scanned object data upon scanning an object. Such scanning technologies are well known. The resulting scanned object data is provided to logic 110 and/or stored in memory 112.

Network interface 120 is representative of any communication technology that allows data to be shared between logic 110 and/or memory 112 and network 104. Such communication technology is well known. Similarly, communication port 116 is representative of any communication technology that allows data to be shared between logic 110 (and/or memory 112) and portable device 108. Communication port 116 may be configured to provide a wired and/or a wireless communication link to corresponding communication technology (not shown) within portable device 108. In certain implementations, the resulting communications link may include an infrared communications link, for example. Again, such communication technology is well known and beyond the scope of this description.

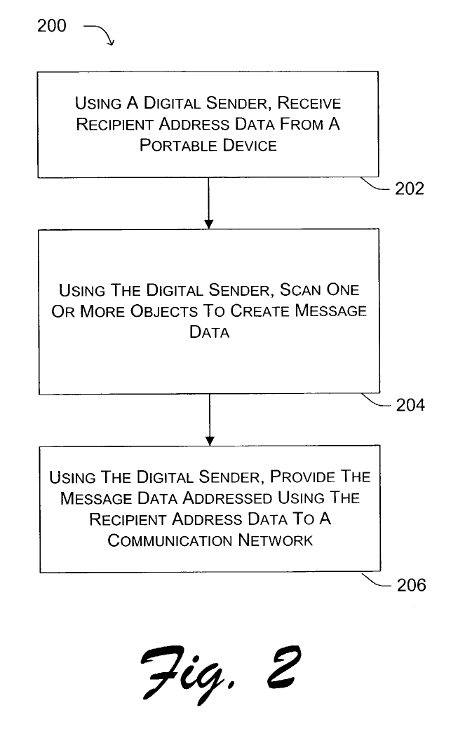

With this in mind, logic 110 is configured to perform the operations described above. By way of further example, a flow diagram is depicted in FIG. 2 to illustrate certain exemplary functions that can be performed using logic 110 and the other resources in digital sender 102. Here, a process 200 is provided.

In step 202, recipient address data 109 is provided to digital sender device 102 by portable device 108. In step 204, message data is generated by using the digital sender to scan at least one object 119. In step 206, the message data is addressed according to the recipient address data received from portable device 108 and provided to network 104. Note, that in certain implementations, steps 202 and 204 may be accomplished in the opposite order

In accordance with still other aspects of the present invention, logic 110 may be configured to maintain at least one recipient address data list within memory 112. The recipient address data list may include a plurality of recipient addresses associated with a plurality of potential message data recipients. Logic 110 may also be configured to selectively modify the recipient address data list based on the received recipient address data from portable device 108.

Thus, although some preferred embodiments of the various methods and apparatuses of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the spirit of the invention as set forth and defined by the following claims.

What is claimed is:

1. A method for use in a digital sender device capable of sending message data, the method comprising:
optically scanning at least one object to form corresponding scanned object data;
receiving recipient address data from a portable device; and
addressing said message data using said recipient address data.

2. The method as recited in claim 1, further comprising:
sending said message data over at least one communication network to at least one remote device connected to said communication network and operatively associated with a user address that is included in said recipient address data.

3. The method as recited in claim 1, wherein said recipient address data includes a plurality of user addresses.

4. The method as recited in claim 1, further comprising:
accepting user input through a user interface of said digital sender device, said user input including user provided data selected from a group of data comprising address data, subject data, and text data; and
wherein addressing said message data using said recipient address data further includes forming said message data by combining said scanned object data, said recipient address data and said user provided data.

5. The method as recited in claim 1, wherein receiving said recipient address data from said portable device includes:
receiving said recipient address data from said portable device over a wireless communication link that operatively couples said digital sender device with said portable device.

6. The method as recited in claim 5, wherein said wireless communication link includes an infrared communications link.

7. The method as recited in claim 1, further comprising:
maintaining at least one recipient address data list within said digital sender device, said recipient address data list comprising a plurality of recipient addresses associated with a plurality of potential message data recipients; and
modifying said at least one recipient address data list based on said received recipient address data.

8. The method as recited in claim 1, wherein said digital sender is included within a multiple function peripheral device, which further includes a printer device that is operatively coupled to said digital sender device.

9. The method as recited in claim 8, further comprising:
selectively printing at least one document using said printer device, said at least one document corresponding to said message data.

10. The method as recited in claim 1, further comprising:
sending said message data to said portable device.

11. An apparatus capable of sending message data, the apparatus comprising:
a scanning mechanism configurable to optically scan at least one object to form corresponding scanned object data;
at least one communication port configurable to receive recipient address data from a portable device over a communication link, said recipient address data including at least one address associated with an intended message data recipient; and
logic operatively coupled to said scanning mechanism and said at least one communication port, said logic being configured to form message data by combining said scanned object data and said recipient address data, and wherein said message data is configured to at least be sent to said at least one address associated with said intended message data recipient.

12. The apparatus as recited in claim 11, further comprising:
at least one network interface operatively coupled to said logic and configurable to send said message data to said intended message data recipient over at least one communication network.

13. The apparatus as recited in claim 11, wherein said additional mail data includes a plurality of addresses associated with a plurality of intended message data recipients.

14. The apparatus as recited in claim 11, further comprising:
a user interface operatively coupled to said logic and configured to accept user input, said user input including user provided data selected from a group of data comprising address data, subject data, and text data; and
wherein said logic is further configured to form said message data by combining said scanned object data, said recipient address data and said user provided data.

15. The apparatus as recited in claim 11, wherein said communication link includes a wireless communication link.

16. The apparatus as recited in claim 15, wherein said wireless communication link includes an infrared communications link.

17. The apparatus as recited in claim 11, further comprising:
memory that is operatively coupled to said logic, and
wherein said logic is further configured to maintain at least one recipient address data list within said memory, said recipient address data list comprising a plurality of addresses associated with a plurality of potential message data recipients, and said logic is further configured to modify said at least one recipient address data list based on said received recipient address data.

18. The apparatus as recited in claim 11, wherein said apparatus is included within a multiple function peripheral device, and said multiple function peripheral device further includes a printer device that is operatively coupled to said logic.

19. The apparatus as recited in claim 18, wherein said logic is further configured to cause said printer device to selectively print at least one document corresponding to said message data.

20. The apparatus as recited in claim 11, wherein said at least one communication port is further configurable to provide said message data to said portable device over said communication link.

21. A computer-readable medium having computer-executable instructions for causing logic to perform acts comprising:
optically scanning at least one object to form corresponding scanned object data;
receiving recipient address data from a portable device; and
addressing said message data using said recipient address data.

22. The computer-readable medium as recited in claim 21, having further computer-executable instructions for causing logic to perform acts comprising:
sending said message data over at least one communication network to at least one remote device connected to said communication network and operatively associated with a user address that is included in said recipient address data.

23. The computer-readable medium as recited in claim 21, wherein said recipient address data includes a plurality of user addresses.

24. The computer-readable medium as recited in claim 21, having further computer-executable instructions for causing logic to perform acts comprising:
accepting user input through a user interface of said digital sender device, said user input including user provided data selected from a group of data comprising address data, subject data, and text data; and
wherein addressing said message data using said recipient address data further includes forming said message data by combining said scanned object data, said recipient address data and said user provided data.

25. The computer-readable medium as recited in claim 21, wherein receiving said recipient address data from said portable device includes:
receiving said recipient address data from said portable device over a wireless communication link that operatively couples said digital sender device with said portable device.

26. The computer-readable medium as recited in claim 25, wherein said wireless communication link includes an infrared communications link.

27. The computer-readable medium as recited in claim 21, having further computer-executable instructions for causing logic to perform acts comprising:
maintaining at least one recipient address data list within said digital sender device, said recipient address data list comprising a plurality of recipient addresses associated with a plurality of potential message data recipients; and
modifying said at least one recipient address data list based on said received recipient address data.

28. The computer-readable medium as recited in claim 21, wherein said digital sender is included within a multiple function peripheral device, which further includes a printer device that is operatively coupled to said digital sender device.

29. The computer-readable medium as recited in claim 28, having further computer-executable instructions for causing logic to perform acts comprising:
selectively printing at least one document using said printer device, said at least one document corresponding to said message data.

30. The computer-readable medium as recited in claim 21, having further computer-executable instructions for causing logic to perform acts comprising:
sending said message data to said portable device.

31. A computing device configured to access a computer-readable medium having computer-executable instructions for causing logic to perform acts comprising:
optically scanning at least one object to form corresponding scanned object data;
receiving recipient address data from a portable device; and
addressing said message data using said recipient address data.

32. The computing device as recited in claim 31, wherein said computer-readable medium includes further computer-executable instructions for causing logic to perform acts comprising:
sending said message data over at least one communication network to at least one remote device connected to said communication network and operatively associated with a user address that is included in said recipient address data.

33. The computing device as recited in claim 31, wherein said recipient address data includes a plurality of user addresses.

34. The computing device as recited in claim 31, wherein said computer-readable medium includes further computer-executable instructions for causing logic to perform acts comprising:
accepting user input through a user interface of said digital sender device, said user input including user provided data selected from a group of data comprising address data, subject data, and text data; and
wherein addressing said message data using said recipient address data further includes forming said message data by combining said scanned object data, said recipient address data and said user provided data.

35. The computing device as recited in claim 31, wherein receiving said recipient address data from said portable device includes:
receiving said recipient address data from said portable device over a wireless communication link that operatively couples said digital sender device with said portable device.

36. A digital sender device capable of sending message data, the digital sender device comprising:
means for optically scanning at least one object to form corresponding scanned object data;
means for receiving recipient address data from a portable device; and
means for addressing said message data using said recipient address data.

37. The method as recited in claim 36, further comprising:
means for sending said message data over at least one communication network to at least one remote device connected to said communication network and operatively associated with a user address that is included in said recipient address data.

38. The method as recited in claim 36, wherein said recipient address data includes a plurality of user addresses.

39. The method as recited in claim 36, further comprising:
means for accepting user input through a user interface of said digital sender device, said user input including user provided data selected from a group of data comprising address data, subject data, and text data; and
wherein addressing said message data using said recipient address data further includes forming said message data by combining said scanned object data, said recipient address data and said user provided data.

40. The method as recited in claim 36, wherein said means for receiving said recipient address data from said portable device includes:
means for receiving said recipient address data from said portable device over a wireless communication link that operatively couples said digital sender device with said portable device.

41. The method as recited in claim 40, wherein said wireless communication link includes an infrared communications link.

42. The method as recited in claim 36, further comprising:
means for maintaining at least one recipient address data list within said digital sender device, said recipient address data list comprising a plurality of recipient addresses associated with a plurality of potential message data recipients; and
means for modifying said at least one recipient address data list based on said received recipient address data.

43. The method as recited in claim 36, wherein said digital sender is included within a multiple function peripheral device, which further includes a printer device that is operatively coupled to said digital sender device.

44. The method as recited in claim 43, further comprising:
means for selectively printing at least one document using said printer device, said at least one document corresponding to said message data.

45. The method as recited in claim 36, further comprising:
means for sending said message data to said portable device.
